(19) United States
(12) Patent Application Publication
(10) Pub. No.: US 2011/0056722 A1
(43) Pub. Date: Mar. 10, 2011

(54) Wiring Duct Cover With Foam Insert

(75) Inventor: Jack E. Caveney, North Palm Beach, FL (US)

(73) Assignee: PANDUIT CORP., Tinley Park, IL (US)

(21) Appl. No.: 12/709,791

(22) Filed: Feb. 22, 2010

Related U.S. Application Data
(60) Provisional application No. 61/154,633, filed on Feb. 23, 2009.

(51) Int. Cl. H02G 3/04

(52) U.S. Cl. 174/68.3

(57) ABSTRACT

A wiring duct includes a base and a snap-on or hinged cover. The base has a bottom wall and two sidewalls extending perpendicularly from the bottom wall. Each sidewall may include a projection to receive a snap-on cover. The snap-on or hinged cover includes a foam insert attached to the bottom side of the cover by adhesive. Support members may be attached to the sides of the foam insert to provide containment when the foam insert is positioned within the base of the wiring duct. When the snap-on or hinged cover is fully installed on the base, the foam insert is compressed between the base, the cables and the cover to block airflow within the wiring duct.

### CROSS-REFERENCE TO RELATED APPLICATION

This application claims priority to U.S. Provisional Application No. 61/154,633, filed Feb. 23, 2009, the subject matter of which is hereby incorporated by reference in its entirety.

### BACKGROUND OF THE INVENTION

The present invention relates to a wiring duct cover with a foam insert and, in particular, the invention relates to a fiber duct cover with a foam insert to block airflow within a fiber duct.

Currently available wiring duct having solid walls may include snap-on or hinged covers. Panduit Corp.'s Type FS wiring duct is an example of a solid wall raceway having a snap-on cover, and Panduit Corp.'s Type HS wiring duct is an example of a solid wall raceway having a hinged cover. Either type of wiring duct may be used to fully enclose cables and provide cable protection in a vertical cable drop. However, neither type of wiring duct provides the ability to block airflow within the wiring duct.

Therefore, there is a need for a wiring duct that blocks airflow within the wiring duct, especially in vertical cable drops into a network cabinet.

### SUMMARY OF INVENTION

A wiring duct includes a base and a snap-on or hinged cover. The base has a bottom wall and two sidewalls extending perpendicularly from the bottom wall. Each sidewall may include a projection to receive a snap-on cover. The snap-on or hinged cover includes a foam insert attached to the bottom side of the cover by adhesive. Support members may be attached to the sides of the foam insert to provide containment when the foam insert is positioned within the base of the wiring duct. When the snap-on or hinged cover is fully installed on the base, the foam insert is compressed between the base, the cables and the cover to block airflow within the wiring duct.

### BRIEF DESCRIPTION OF THE DRAWINGS

FIG. 1 is a top perspective view of a wiring duct in accordance with the present invention, wherein the wiring duct connects a fiber spillover fitting to the top of a network cabinet;

FIG. 2 is a cross-sectional view of the wiring duct of FIG. 1, wherein a snap-on cover with a foam insert is being secured to a base of the wiring duct;

FIG. 3 is a side perspective view of the cover of FIG. 2;

FIG. 4 is a cross-sectional view of a wiring duct in accordance with another embodiment of the present invention, wherein a snap-on cover with a foam insert is being secured to a base of the wiring duct;

FIG. 5 is a top perspective view of a wiring duct in accordance with a further embodiment of the present invention, wherein a hinged cover is in the open position;

FIG. 6 is a cross-sectional view of the wiring duct of FIG. 5, wherein the hinged cover is being closed; and

FIG. 7 is a cross-sectional view of the wiring duct of FIG. 5, wherein the hinged cover is in the closed position.

### DETAILED DESCRIPTION

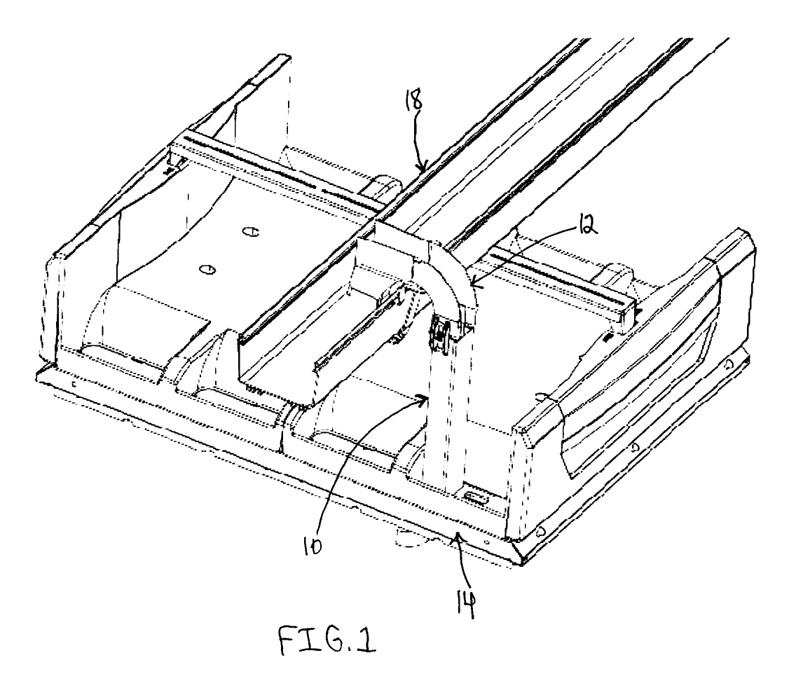

FIG. 1 illustrates a wiring duct 10 connecting a fiber spillover fitting 12 to the top of a network cabinet 14. Preferably, wiring duct 10 is Panduit Corp. Type FS wiring duct. However, it is contemplated that the present invention may use other solid wall wiring duct. Typically, cables are routed out of cable trough 18 upward into spillover fitting 12, which provides bend radius control for cables passing therethrough. Cables exit spillover fitting 12, pass through wiring duct 10 and enter the top of network cabinet 14. Network cabinet 14 may include various types of servers, switches and other electronic components.

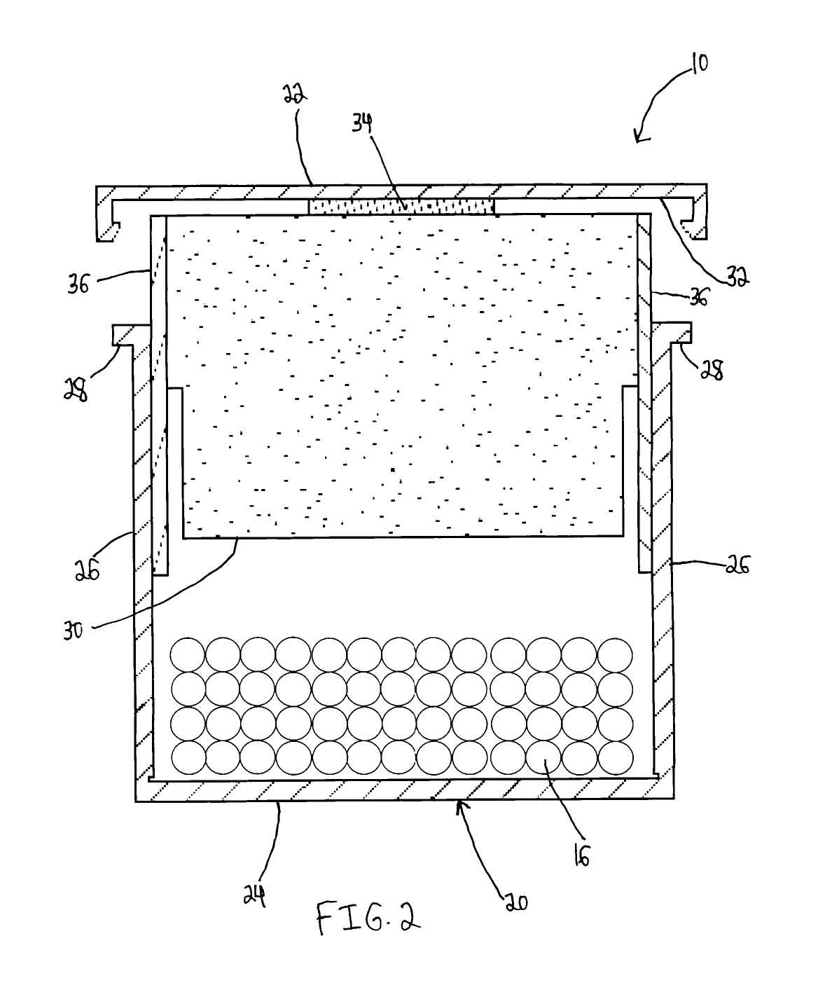

As shown in FIG. 2, wiring duct 10 includes base 20 and snap-on cover 22. Base 20 has a bottom wall 24 and two solid sidewalls 26 extending perpendicularly from bottom wall 24. Each sidewall 26 includes a projection 28 to receive cover 22.

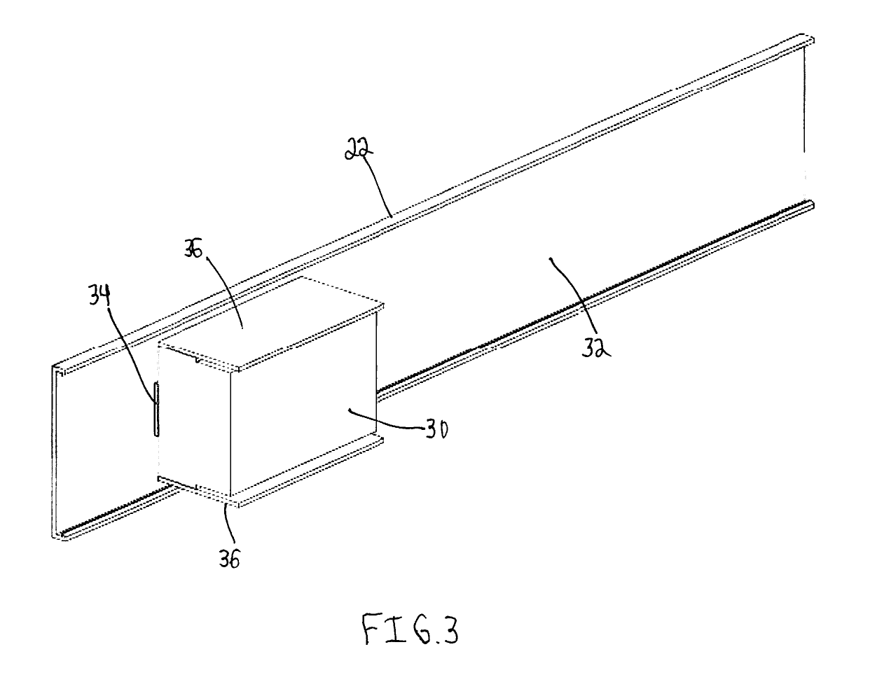

As shown in FIGS. 2 and 3, cover 22 includes foam insert 30. Foam insert 30 is substantially rectangular and is attached to bottom side 32 of cover 22 by adhesive 34. Foam insert 30 may be attached to cover 22 by other means known in the art. Support members 36 attach to the sides of foam insert 30 and extend along the length of foam insert 30 to provide containment when foam insert 30 is positioned within base 20 of wiring duct 10. When cover 22 is fully installed on base 20, foam insert 30 is compressed between base 20, cables 16 and cover 22 to block airflow within wiring duct 10.

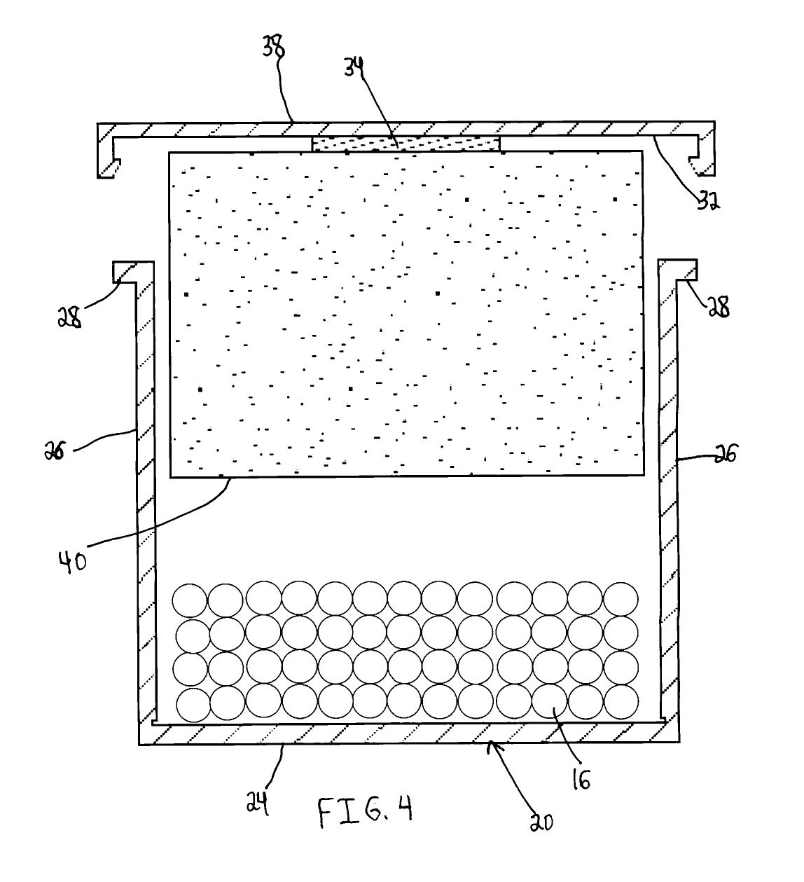

FIG. 4 illustrates another embodiment of a snap-on cover 38. Cover 38 is identical to cover 22, but foam insert 40 does not include support members. Cover 38 functions in a similar manner to cover 22.

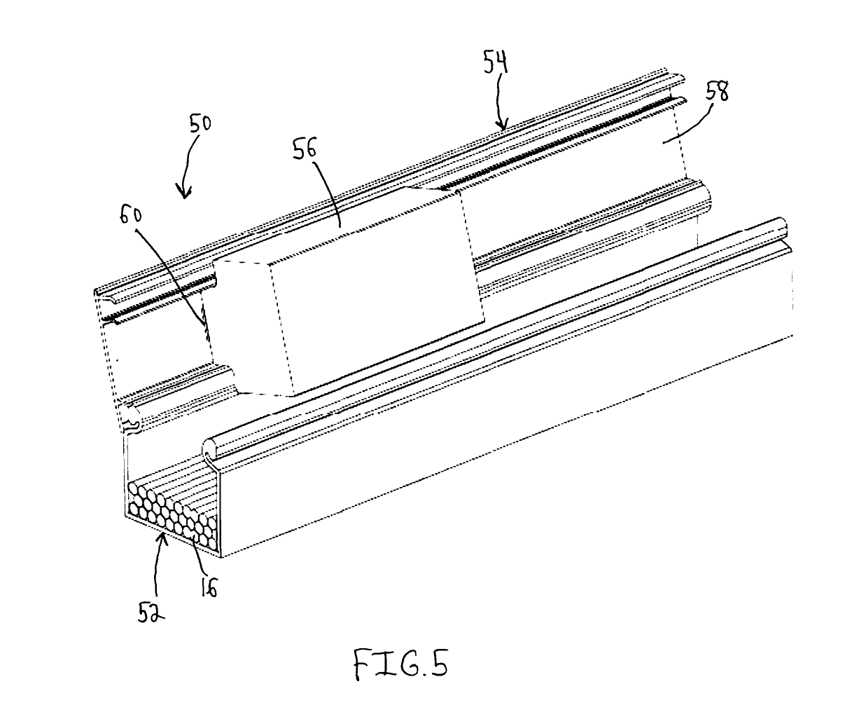

FIGS. 5-7 illustrate another embodiment of wiring duct 10, referred to as wiring duct 50. Preferably, wiring duct 50 is Panduit Corp. Type HS wiring duct. However, it is contemplated that the present invention may use other solid wall wiring duct.

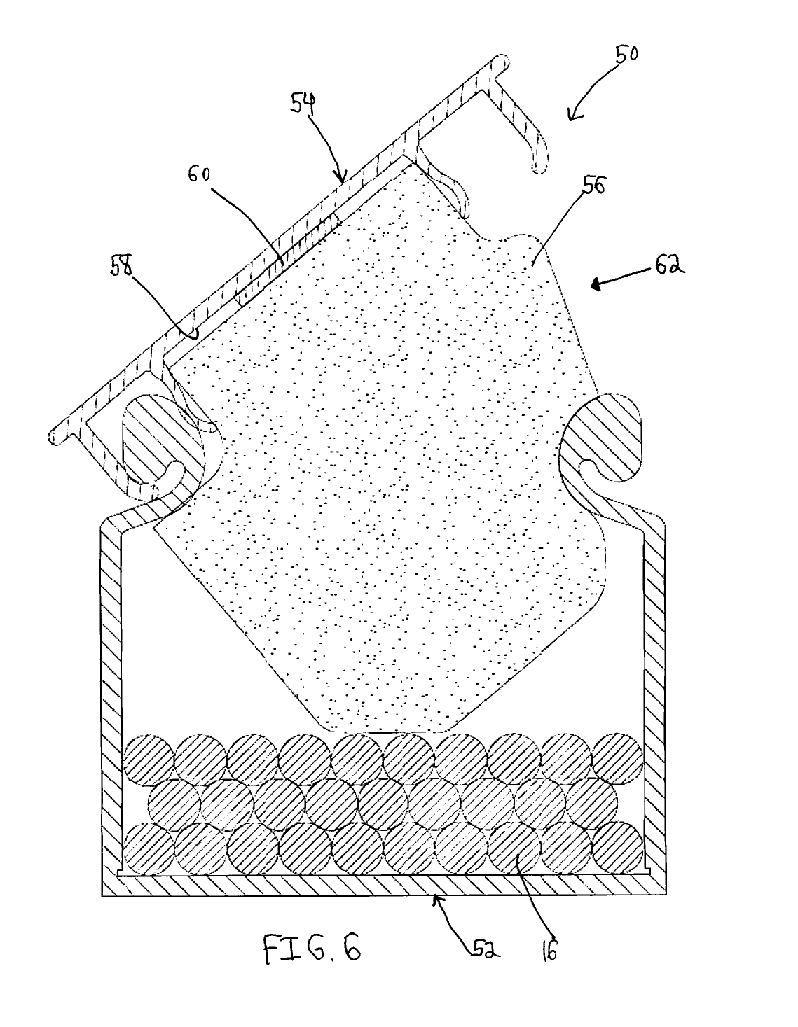

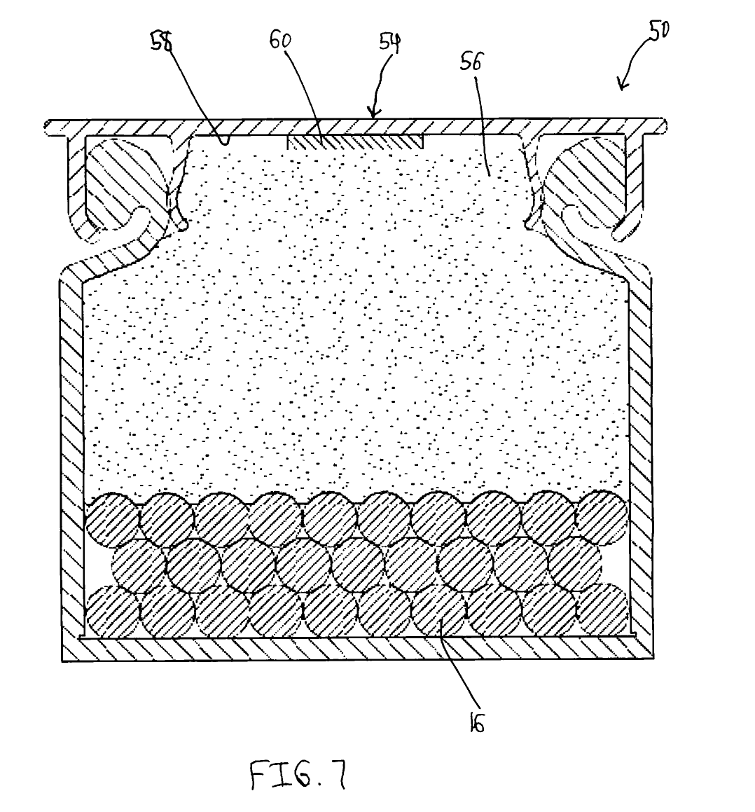

Base 52 is similar to base 20, but base 52 is configured to engage with hinged cover 54. Cover 54 includes foam insert 56. Foam insert 56 is substantially rectangular and is attached to bottom side 58 of cover 54 by adhesive 60. Foam insert 56 may be attached to cover 54 by other means known in the art. As shown in FIG. 6, foam insert 56 is pushed in the direction of arrow 62 as cover 54 is rotated down to avoid pinching foam insert 56. As shown in FIG. 7, when cover 54 is fully installed on base 52, foam insert 56 is compressed between base 52, cables 16 and cover 54 to block airflow within wiring duct 50.

1. A wiring duct comprising:
a base having a bottom wall and two sidewalls extending substantially perpendicularly from the bottom wall; and
a cover connected to the base, the cover having a top side and a bottom side,
wherein the cover includes a compressible member attached to the bottom side of the cover.

2. The wiring duct of claim 1, wherein the compressible member is foam.

3. The wiring duct of claim 1, wherein the compressible member is attached to the bottom side of the cover by adhesive.

4. The wiring duct of claim 1, wherein the compressible member is substantially rectangular.

5. The wiring duct of claim 1, wherein the compressible member has a first side and a second side opposite the first side, the compressible member including a first support member attached to the first side.

6. The wiring duct of claim 5, wherein the compressible member includes a second support member attached to the second side.

7. The wiring duct of claim 1, wherein the cover is a snap-on cover.

8. The wiring duct of claim 1, wherein the cover is a hinged cover rotatable from a first, open position to a second, closed position.

9. The wiring duct of claim 8, wherein when the cover is rotated from the open position to the closed position, the compressible member is compressed between the base, cables positioned within the base and the cover to substantially block airflow within the wiring duct.
